(19) United States
(12) Patent Application Publication
(10) Pub. No.: US 2019/0137667 A1
(43) Pub. Date: May 9, 2019

(54) TIR IMAGE DISPLAY WITH AN INDEX PERTURBATION ARRAY

(71) Applicant: CLEARink Displays, Inc., Fremont, CA (US)

(72) Inventors: Alex Henzen, Bladel (NL); Lorne A. Whitehead, Vancouver (CA)

(73) Assignee: CLEARink Displays, Inc., Fremont, CA (US)

(21) Appl. No.: 16/306,710

(22) PCT Filed: Jun. 8, 2017
(86) PCT No.: PCT/US17/36554

§ 371 Date: Dec. 3, 2018

Related U.S. Application Data
(60) Provisional application No. 62/348,701, filed on Jun. 10, 2016.

(51) Int. Cl. G02B 5/02; G02B 26/08; G02F 1/19; G02F 1/167; G02F 1/315

(52) U.S. Cl. CPC G02B 5/0252; G02B 26/0875; G02B 2005/1804; G02F 1/167; G02F 1/315; G02F 1/19

(57) ABSTRACT

Maximizing brightness in conventional total internal reflection image displays may lead to more applications where they may be used. A refractive index perturbation array may be used to enhance the brightness. Control of the size, spacing and refractive index in an index perturbation array layer may lead controlled diffraction of light and lead to enhanced brightness in total internal reflection image displays.

The instant specification claims priority to the U.S. Provisional Application Ser. No. 62/348,701 filed Jun. 10, 2016, the specification of which is incorporated herein in its entirety.

### FIELD

The disclosed embodiments generally relate to total internal reflection (TIR) in high brightness, wide viewing angle image displays. In one embodiment, the disclosure relates to a TIR-based image display comprising a front sheet that further comprises an index perturbation array.

### BACKGROUND

Conventional total internal reflection (TIR) based displays include, among others, a transparent high refractive index front sheet in contact with a low refractive index fluid. The front sheet and fluid may have different refractive indices that may be characterized by a critical angle θ_{c}. The critical angle characterizes the interface between the surface of the transparent front sheet (with refractive index η₁) and the low refractive index fluid (with refractive index η₃). Light rays incident upon the interface at angles less than θ_{c} may be transmitted through the interface. Light rays incident upon the interface at angles greater than θ_{c} may undergo TIR at the interface. A small critical angle (e.g., less than about 50°) is preferred at the TIR interface since this affords a large range of angles over which TIR may occur. It may be prudent to have a fluid medium with preferably as small a refractive index (η₃) as possible and to have a transparent front sheet composed of a material having a refractive index (η₁) preferably as large as possible. The critical angle, θ_{c}, is calculated by the following equation (Eq. 1):

θ_{c}=sin⁻¹(η₃/η₁) (1)

Conventional TIR-based reflective image displays further include electrophoretically mobile, light absorbing particles. The electrophoretically mobile particles move in response to a bias between two opposing electrodes. When particles are moved by a voltage bias source to the surface of the front sheet they may enter the evanescent wave region where TIR may be frustrated. The depth of the evanescent wave region is typically about 0.25 mm, though this can vary with wavelength of incident light and the refractive indices of the front sheet and medium. Incident light may be absorbed by the electrophoretically mobile particles to create a dark state observed by the viewer. Under such conditions, the display surface may appear dark or black to the viewer. When the particles are moved out of the evanescent wave region (e.g., by reverse biasing), light may be reflected by TIR. This creates a white or bright state that may be observed by the viewer. An array of pixelated electrodes may be used to drive the particles into and out of the evanescent wave region to form combinations of white and dark states. This may be used to create images or to convey information to the viewer.

The front sheet in conventional TIR-based displays typically includes a plurality of close-packed convex structures on the inward side facing the low refractive index medium and electrophoretically mobile particles (i.e., the surface of the front sheet which faces away from the viewer). The convex structures may be hemispherically-shaped but other shapes may be used. A conventional TIR-based display 100 is illustrated in FIG. 1. Display 100 is shown with a transparent front sheet 102 further comprising a layer of a plurality of hemispherical protrusions 104, a rear support sheet 106, a transparent front electrode 108 on the surface of the hemispherical protrusions and a rear electrode 110. FIG. 1 also shows low refractive index fluid 112 which is disposed within the cavity or gap formed between the surface of protrusions 104 and the rear support sheet. The fluid 112 contains a plurality of light absorbing electrophoretically mobile particles 114. Display 100 includes a voltage source 116 capable of creating a bias across the cavity. When particles 114 are electrophoretically moved near the front electrode 108, they may frustrate TIR. This is shown to the right of dotted line 118 and is illustrated by incident light rays 120 and 122 being absorbed by the particles 114. This area of the display will appear as a dark state to viewer 124.

When particles are moved away from front sheet 102 towards rear electrode 110 (as shown to the left of dotted line 118) incident light rays may be totally internally reflected at the interface of the surface of electrode 108 on hemispherical array 104 and medium 112. This is represented by incident light ray 126, which is totally internally reflected and exits the display towards viewer 124 as reflected light ray 128. The display appears white or bright to the viewer.

In some instances, light rays may not be totally internally reflected and may instead pass through front sheet 102 and then be lost or internally absorbed. Such conditions decrease the overall brightness of the display. Light ray 130 in FIG. 1 represents a light ray that is incident on the interface at less than the critical angle. Light ray 130 passes through the so called dark pupil region and is not reflected. Thus, brightness in conventional total internal reflection image displays may decrease due to incident light passing through the dark pupil region in the white state.

This application describes a TIR image display comprising of a front sheet that is absent a plurality of convex protrusions. The front sheet may be designed to utilize volumetric phase holography to create an enhanced brightness reflective image display. The front sheet may comprise non-absorptive refractive index variations that together form a refractive index perturbation array.

### BRIEF DESCRIPTION OF DRAWINGS

These and other embodiments of the disclosure will be discussed with reference to the following exemplary and non-limiting illustrations, in which like elements are numbered similarly, and where:

FIG. 1 schematically illustrates a cross-section of a portion of a conventional TIR-based display;

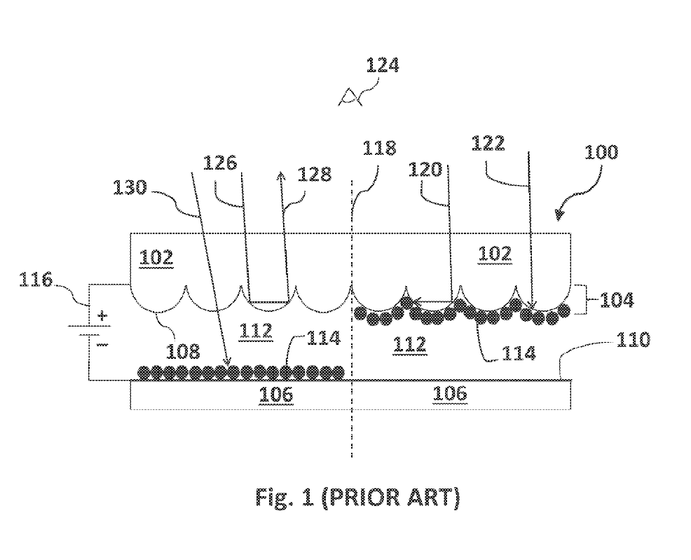

FIG. 2 schematically illustrates a cross-section of a portion of a front sheet design comprising of index perturbation array according to one embodiment of the disclosure;

FIG. 3 schematically illustrates a cross-section of a portion of a TIR-based image display comprising an index perturbation array according to one embodiment of the disclosure; and

FIG. 4 shows an exemplary system for controlling a display according to one embodiment of the disclosure.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive or exclusive, sense.

This disclosure generally relates to an enhanced brightness TIR image display. According to certain embodiments of the disclosure, a TIR image display further comprises a front sheet comprising an index perturbation array (may also be referred to as a holographic grating array). A TIR image display may further comprise of a sheet with a refractive index of greater than about 1.4 that is adjacent the index perturbation array. In some embodiments, the display comprises a low index of refraction medium further comprising electrophoretically mobile particles. The medium may have a refractive index of less than about 1.5. In certain embodiments, incident light may be re-directed by the index perturbation array such that the angle of the re-directed light is directed towards the interface of a sheet with a refractive index of greater than about 1.4 and the low refractive index medium. The angle of the re-directed light rays may be greater than the critical angle, θ_{c}, to allow for total internal reflection of the incident light rays. The totally internally reflected light rays may then be re-directed back towards a viewer to create a bright state of the display.

In certain embodiments, a reflective display comprising an index perturbation array may further comprise a light modulation layer. The light modulation layer may include a transparent medium (e.g., liquid or gas) that receives a plurality of electrophoretically mobile particles. A bias source may be used to apply a bias to move electrophoretically mobile particles in a light modulation layer (i.e., transparent medium) to the interface of the high refractive index sheet and low refractive index medium. The particles may enter the evanescent wave region and frustrate TIR to create a dark state of the display.

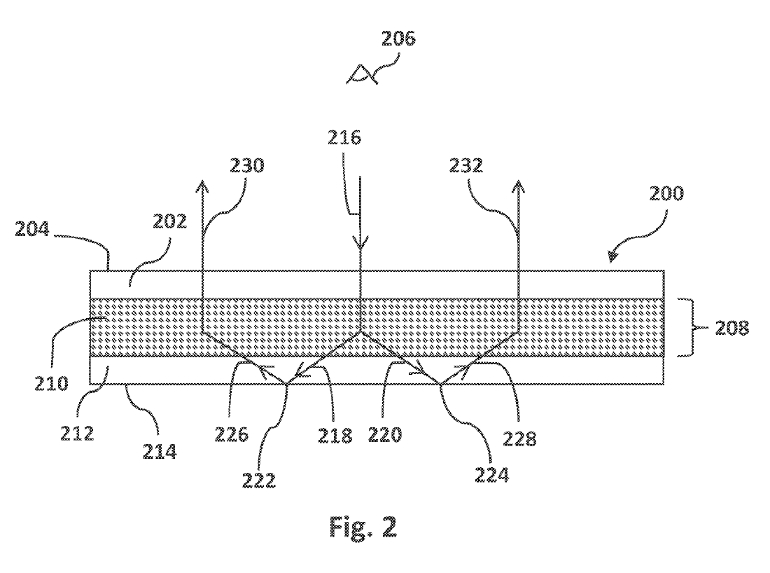

FIG. 2 schematically illustrates a cross-section of a portion of a front sheet design comprising of an index perturbation array according to one embodiment of the disclosure. Front sheet design embodiment 200 in FIG. 2 may comprise a first transparent layer 202 with an outward surface 204 facing viewer 206. Layer 202 may be optional. In some embodiments, layer 202 may comprise one or more of glass or a transparent polymer. In other embodiments, layer 202 may comprise a composite of inorganic particles dispersed in a transparent polymer matrix. The inorganic particles may be metal oxides. The metal oxides may comprise one or more of SiO₂, ZrO₂, ZrO, ZnO₂, ZnO or TiO₂. Layer 202 may be used as a protective layer to prevent physical damage or ultra-violet (UV) light damage. Layer 202 may be used for structural stability. Layer 202 may be at least about 1 micron thick. Layer 202 may have a thickness in the range of about 1-5000 microns.

Front sheet design embodiment 200 in FIG. 2 may further comprise a second layer 208 adjacent the inward surface of first layer 202. In some embodiments, layer 208 may comprise one or more of glass or a transparent polymer. In some embodiments, layer 208 may be at least about 1 micron thick. In other embodiments, layer 208 may be in the range of about 1-5000 microns thick. Second layer 208 may further comprise an array of non-absorptive refractive index variations 210. The array of refractive index variations 210 may also be referred to as a refractive index perturbation array (may also be referred to as a holographic grating array). The index perturbation array 210 may form a Bragg grating that diffracts incident light rays into one or more diffracted rays. In some embodiments, the array may be formed of regions or structures of higher refractive index in a matrix of low refractive index. In some embodiments, the difference in refractive index between the regions of high refractive index and the matrix of low refractive index may be at least about 0.01. In other embodiments, the difference in refractive index between the regions of high refractive index and the matrix of low refractive index may be in the range of about 0.01-1.5. In other embodiments, array 210 may be formed of regions of lower refractive index in a matrix of high refractive index. In some embodiments, the difference in refractive index between the regions of low refractive index and the matrix of high refractive index may be at least about 0.01. In other embodiments, the difference in refractive index between the regions of low refractive index and the matrix of high refractive index may be in the range of about 0.01-1.5. In other embodiments, array 210 may comprise a smoothly varying refractive index throughout layer 208. The regions of higher refractive index or regions of lower refractive index within array 210 may be spaced in a periodic manner or in a random manner or a combination thereof. The array of refractive index regions 210 may vary by one or more of the distance or spacing of the regions, the pattern of the regions, the shape and dimensions of the regions and the refractive index of the regions. In certain embodiments, the high refractive index regions may have a refractive index in the range of about 1.4 to 2.2. In certain other embodiments, the high refractive index protrusions may be a material having a refractive index in the range of about 1.6 to about 1.9.

In embodiment 200 in FIG. 2, array 210 of regions in layer 208 are represented by diamonds for illustrative purposes only. The regions of higher or lower refractive index represented by diamonds may be in any shape or size. The individual regions may be in a three-dimensional shape of one or more of a cube, orb, cylinder, prism, pyramid or other shape. The desired pattern of index perturbation array 210 may be formed by optical interferometry of a suitable photo-sensitive material or other methods. The array of regions 210 may form a smoothly varying refractive index throughout layer 208.

Embodiment 200 in FIG. 2 may further comprise an optional third layer 212 with inward surface 214. Third layer 212 may comprise a glass, a transparent polymer or a composite. In other embodiments, layer 212 may comprise a composite of inorganic particles dispersed in a transparent polymer matrix. The inorganic particles may be metal oxides. The inorganic particles may have a refractive index of at least about 1.5. The metal oxides may comprise one or more of SiO₂, ZrO₂, ZrO, ZnO₂, ZnO or TiO₂. In some embodiments, the composite may comprise inorganic particles dispersed in a transparent polymer matrix. Third layer 212 may be used for structural integrity, rigidity, flexibility or protection. In an exemplary embodiment, layer 212 may be used as a substrate to deposit an electrode layer onto or a combination thereof. In some embodiments, layer 212 may be at least about 1 micron thick. In other embodiments, layer 212 may be in the range of about 1-5000 microns thick. Layer 212 may have a refractive index of at least about 1.4. In some embodiments, the refractive index of layer 212 may be in the range of about 1.4-2.2. In other embodiments, the refractive index of layer 212 may be in the range of about 1.6-1.9.

In some embodiments, front sheet embodiment 200 in FIG. 2 may not include a first layer 202 or a third layer 212 or either layer. In some embodiments a front sheet may only include a layer comprising of an index perturbation array 210. Such a layer may be able to comprise array 210 and provide one or more of structural integrity, rigidity or flexibility. The layer may additionally provide protection against physical or UV light damage. The thicknesses of first layer 202, second layer 208 and third layer 212 layers may vary independently with respect to each other.

Front sheet embodiment 200 in FIG. 2 may behave as follows. Incident light ray 216 may pass through the first transparent outer layer 202 and into second layer 208 comprising of the index perturbation array 210. Index perturbation array 210 may be designed in such a manner by varying the spacing distance, pattern, shape and refractive index of the regions in array 210 to substantially predictably control the diffraction pattern of the diffracted incident light ray 216. Incident light ray 216 may be diffracted into light rays 218, 220 at substantially controlled angles such that they pass through layer 212 and approach surface 214 at an angle greater than the critical angle θ_{c}. If the angle is greater than θ_{c}, total internal reflection may occur at surface 214 at points 222, 224 and reflect light back towards layer 208 (though not shown in FIG. 2, surface 214 is adjacent to a medium of low refractive index). This is represented by light rays 226 and 228. As totally internally reflected light rays 226, 228 enter layer 208 comprising of index perturbation array 210, the light rays may be directed back towards transparent front sheet 202 and viewer 206. This is represented by light rays 230, 232 in FIG. 2. Other modes of light diffraction patterns may be possible. The light diffraction illustrated in FIG. 2 is for illustrative purposes only.

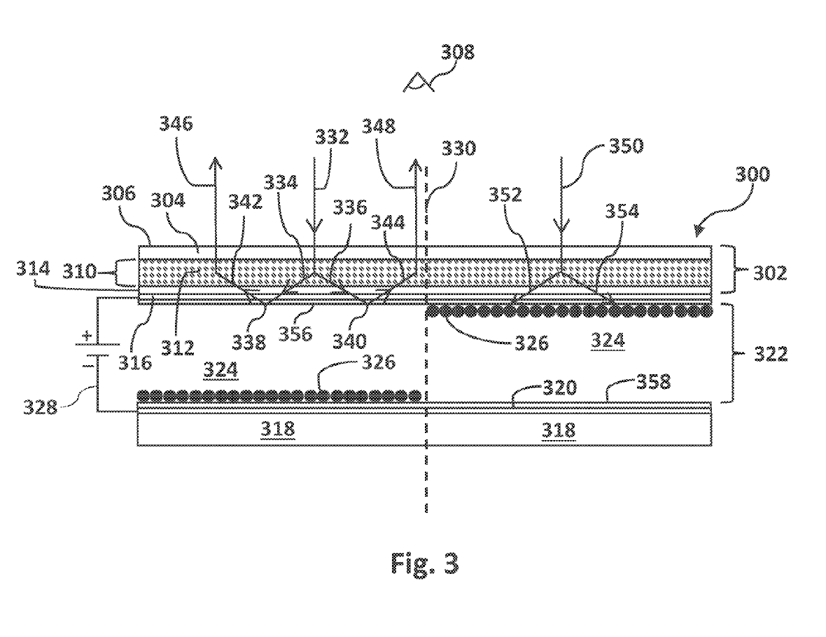

FIG. 3 schematically illustrates a cross-section of a portion of a TIR-based image display comprising an index perturbation array according to one embodiment of the disclosure. Display 300 in FIG. 3 comprises a front sheet 302 similar to that described in FIG. 2. Sheet 302 may comprise an optional first transparent outward layer 304 with outward surface 306 facing viewer 308. Sheet 302 may further comprise second layer 310. Second layer 310 may comprise index perturbation layer 312 as previously described herein. Sheet 302 may further comprise optional third transparent layer 314 as previously described herein. In some embodiments, layer 314 may have a refractive index of at least about 1.4. In other embodiments, layer 314 may have a refractive index of about 1.4-2.2. In still other embodiments, layer 314 may have a refractive index of about 1.6-1.9. In some embodiments, layer 302 may be continuous.

On the inward surface of layer 314 comprises transparent front electrode layer 316. In other embodiments, front electrode layer 316 may be deposited directly onto layer 310 that comprises an index perturbation array. Front electrode layer 316 may be comprised of one or more of indium tin oxide (ITO), an electrically conducting polymer such as BAYTRON™ or conductive nanoparticles, metal nanowires, graphene or other conductive carbon allotropes or a combination of these materials dispersed in a substantially transparent polymer.

Display 300 in FIG. 3 may further comprise a rear support sheet 318. Sheet 318 may comprise one or more of a metal, polymer, ceramic, wood or other material. Sheet 318 may comprise one or more of glass, polycarbonate, polymethylmethacrylate (PMMA), polyurethane, acrylic, polyvinylchloride (PVC) or polyethylene terephthalate (PET). Sheet 318 may be rigid or flexible. Rear electrode layer 320 may be located on the inward surface of sheet 318. Rear electrode 320 may comprise one or more of a thin film transistor (TFT) array, patterned direct drive array or a passive matrix array of electrodes. Rear electrode layer 320 may be embedded in rear support sheet 318. Rear sheet 318 may be flexible. Rear sheet 318 may provide structural integrity and rigidity to the display.

In some embodiments, sheet 318 may further comprise an adhesive layer. The adhesive layer may comprise of a polymer. The adhesive layer may comprise one or more of a solvent-based adhesive, emulsion adhesive, polymer dispersion adhesive, pressure-sensitive adhesive, contact adhesive, hot-melt adhesive, multi-component adhesive, ultra-violet (UV) light curing adhesive, heat curing adhesive, moisture curing adhesive, natural adhesive or any other synthetic adhesive. In other embodiments, sheet 318 may further comprise an adhesive layer and a release sheet. The release sheet may be readily removed to expose the adhesive layer where display 300 may be adhered or laminated to any structure or location where the display is desired.

In some embodiments an optional dielectric layer 356 may be located on the surface of transparent front electrode 316. In other embodiments an optional dielectric layer 358 may be located on top of the rear electrode layer 320. In some embodiments, dielectric layer 356 on front electrode 318 may comprise of a different composition than dielectric layer 358 on rear electrode 320. The dielectric layers may be substantially uniform, continuous and substantially free of surface defects. The dielectric layer thickness may be at least about 5 nm. In some embodiments, the dielectric layer thickness may be about 5 to 300 nm. In other embodiments, the dielectric layer thickness may be about 5 to 200 nm. In still other embodiments, the dielectric layer thickness may be about 5 to 100 nm. The dielectric layers may each have a thickness of at least about 80 nanometers. In an exemplary embodiment, the thickness may be about 80-200 nanometers. The one or more dielectric layers may comprise at least one pin hole. The dielectric layer may define a conformal coating and may be free of pin holes or may have minimal pin holes. The dielectric layer may also be a structured layer. The dielectric layer may be a patterned layer. Dielectric compounds may be organic or inorganic in type. In some embodiments the dielectric layer may be alumina (Al₂O₃) or SiO₂. The dielectric layer may be SiNₓ. In some embodiments the dielectric layer may be Si₃N₄. Organic dielectric materials are typically polymers such as polyimides, fluoropolymers, polynorbornenes and hydrocarbon-based polymers lacking polar groups. The dielectric layer may be a polymer or a combination of polymers. In an exemplary embodiment, the dielectric layers comprise parylene. In other embodiments, the dielectric layers may comprise a halogenated parylene. Other inorganic or organic dielectric materials or combinations thereof may also be used for the dielectric layers.

Within gap or cavity 322 formed by front sheet 302 and rear sheet 318 comprises medium 324. Medium 324 may be air or a liquid. In some embodiments, medium 324 may be a hydrocarbon. In other embodiments, medium 324 may be a fluorinated hydrocarbon or a perfluorinated hydrocarbon. In other embodiments, medium 324 may be a mixture of a hydrocarbon and a fluorinated hydrocarbon. Medium 324 may be a low refractive index liquid with a refractive index less than about 1.5. In an exemplary embodiment, the refractive index of medium 324 may be about 1-1.4. In an exemplary embodiment, medium 324 may comprise one or more of Fluorinert™, Novec™ 7000, Novec™ 7100, Novec™ 7300, Novec™ 7500, Novec™ 7700, Novec™ 8200, Teflon AF™, CYTOP™, or FluoroPel™. Medium 324 may further comprise one or more of a dispersant, charging agent, surfactant, flocculating agent, viscosity modifier or a polymer. Conventional viscosity modifiers include oligomers or polymers. Viscosity modifiers may include one or more of a styrene, acrylate, methacrylate or other olefin-based polymers. In one embodiment, the viscosity modifier may be polyisobutylene or a halogenated polyisobutylene.

Medium 324 in embodiment 300 may further comprise a plurality of light absorbing electrophoretically mobile particles 326 of a first optical characteristic (i.e. color or light absorption characteristic). Particles 326 may comprise a positive charge polarity or a negative charge polarity or a combination thereof. Particles 326 may have broadband (i.e., substantially all optical wavelengths) light reflection characteristics. Particles 326 may also have any light absorption characteristic such that particles 326 may impart any color of the visible spectrum or a combination of colors to give a specific shade or hue. Particles 326 may be a dye or pigment or a combination thereof. The particles may be organic or inorganic or a combination thereof. Particles 326 may comprise a metal oxide. Particles 326 may comprise carbon black. Medium 324 may also comprise an electrowetting fluid that moves towards sheet 302 by application of a bias to frustrate TIR and away from sheet 302. The electrowetting fluid may comprise a polar fluid further comprising a dye or pigment in a non-polar transparent fluid. Medium 324 may also comprise a fluid of a different polarity with a black dye suspended or dissolved. The fluid, such as a silicone oil may then be pumped via small channels in or out of wells or compartments. Medium 324 may further comprise a second plurality of particles (not shown in FIG. 3). The second plurality of particles may comprise a charge polarity or may be weakly charged or uncharged. The second plurality of particles may be light absorbing or light reflecting. The particles may be a dye or pigment or a combination thereof. The particles may be organic or inorganic or a combination thereof. In an exemplary embodiment, the second plurality of non-light absorbing particles may comprise TiO₂.

Display 300 may further comprise voltage bias source 328. Bias source 328 creates an electromagnetic flux or field across medium 324 in cavity 322. The electromagnetic flux may electrophoretically move at least one particle of the first plurality of particles 326 or at least one particle of an optional second plurality of particles. The flux may electrophoretically move at least one particle of the first plurality of particles 326 or at least one particle of an optional second plurality of particles anywhere within cavity 322. The flux may be used to move the plurality of particles to the front 316 or rear 320 electrodes or anywhere in between the front and rear electrodes. The flux may be provided and/or adjusted by a controller (e.g., a processor circuitry and optionally a memory circuitry) configured to move mobile particles from one location to another to display information to a viewer. Voltage source 328 may be coupled to one or more processor circuitry and memory circuitry configured to change or switch the applied bias in a predefined manner and/or for predetermined durations. For example, the processing circuitry may switch the applied bias to display characters on display 300.

Display 300 may comprise an array of pixels. Each pixel may be driven by a TFT, passive matrix electrode or a patterned direct drive electrode.

Display 300 may comprise a color filter layer (not shown). A color filter layer may be located over the outward surface 306 of transparent front sheet 304 facing the viewer 308. In some embodiments, a color filter layer may be located between layer 314 and layer 316. In other embodiments, a color filter layer may be located between layer 310 and layer 314. In an exemplary embodiment, a color filter layer may be located between the outer transparent layer 302 and layer 310. The color filter layer may include one or more of red, green, blue, white, cyan, magenta or yellow filters. In an exemplary embodiment, a color filter of a single color may be substantially aligned with a single pixel.

Display 300 in FIG. 3 may be operated as follows. It is assumed that one or more of the plurality of particles 326 comprise a positive charge polarity for illustrative purposes only. In other embodiments particles 326 may comprise a negative charge polarity. On the left side of dotted line 330, a negative voltage bias may be applied by voltage bias source 328 at rear electrode 320 to attract the positively charged light absorbing particles 326 to rear electrode 320. The location of the particles in FIG. 3 is for illustrative purposes only. Particles 326 may be located anywhere between the front and rear electrodes in cavity 322 as long as the particles are not located within the evanescent wave region near front electrode 316. As a result, total internal reflection of incident light may not be frustrated by particles 326 and TIR may be allowed to occur at the interface of the transparent front electrode layer 316 and medium 324. This is represented by incident light ray 332 that may be diffracted by the index perturbation layer 310. In FIG. 3, the diffracted light rays are represented by light rays 334 and 336. Diffracted light rays 334, 336 may be totally internally reflected at the interface of the dielectric layer 356 with medium 324. TIR of light rays 334 and 336 are represented by points 338 and 340, respectively. Light rays 334, 336 may then be totally internally reflected as light rays 342 and 344, respectively, back towards the index perturbation layer 310. In one embodiment of the disclosure, the angle of diffraction may be different for angles 338 and 340. In this manner, the incoming light ray may be diffracted differently based on the region of the array upon which incident ray 332 is exposed. In certain embodiments, the angle of the incident light may define the reflection angle. The light rays may then be redirected towards viewer 308 viewing the display as reflected light rays 346 and 348. This may create a bright or white state appearance of a pixel of display 300 to viewer 308. Other modes of diffraction and reflection may be possible. The modes shown in FIG. 3 are for illustrative purposes only.

Display 300 may also be configured to form a dark state as shown on the right side of dotted line 330. Applying a negative voltage bias by bias source 328 at front electrode 316 may attract the positively charged light absorbing particles 326 towards front electrode layer 316 and into the evanescent wave region. In this location near front electrode 316, particles 326 may absorb light or frustrate TIR to create a dark state of a pixel of display 300. This may be represented by diffracted incident light ray 350 on the right side of dotted line 330. Light rays may pass through top sheet 304 and into index perturbation layer 310 where they may be diffracted. This is represented by diffracted light rays 352 and 354. Light rays 352, 354 may be directed towards the surface of transparent electrode layer 316 at the interface with medium 324. In this location, particles 326 residing in the evanescent wave region may frustrate TIR and absorb the diffracted light rays 352, 354. This may create a dark state of a pixel within display 300. The color that viewer 308 may observe will depend on the color of the light absorbing particles used in the display application. Combinations of white and dark pixel states created by the display design embodiments and by the methods and processes described herein may create images and convey information to the viewers of the display.

Index perturbation arrays 208, 310 may be formed by the method of volumetric phase holography. In one embodiment, the index perturbation array may be formed by an interference-fringe field of two laser beams whose standing-wave pattern is exposed to a polished substrate coated with photoresist. The exposed medium may then be processed which results in a desired diffraction grating pattern.

At least one sidewall (interchangeably, cross-walls or partition walls) may be employed with the disclosed display embodiments. The sidewalls may limit particle settling, drift and diffusion to improve display performance and bistability. The sidewalls may be located within the light modulation layer comprising the particles and medium. The sidewalls may completely or partially extend from the front electrode, rear electrode or both the front and rear electrodes. The sidewalls may completely or partially extend from the front sheet, rear support sheet or both the front and rear sheets. The sidewalls may be continuous with the front sheet or the rear sheet or both the front and rear sheets. The sidewalls may comprise polymer, metal or glass or a combination thereof. The sidewalls may be any size or shape. The sidewalls may have a rounded cross-section. The sidewalls may have a refractive index about the same as the refractive index of sheet 314. In an exemplary embodiment the sidewalls may be optically active. The sidewalls may create wells or compartments (not shown) to confine the electrophoretically mobile particles 326. The sidewalls or cross-walls may be configured to create wells or compartments in, for example, square-like, triangular, pentagonal or hexagonal shapes or a combination thereof. The side walls may comprise a polymeric material and patterned by one or more conventional techniques including photolithography, embossing, micro-replication or molding. The sidewalls may help confine mobile particles 326 to prevent settling and migration of said particles that may lead to poor display performance over time. In certain embodiments, the displays may include sidewalls that completely bridge gap 322 created by front electrode 316 and rear electrode 320 in the region where the air or liquid medium 324 and electrophoretically mobile particles 326 reside. In certain other embodiments, the reflective image display described herein may comprise partial sidewalls that only partially bridge gap 322 created by the front and rear electrodes in the region where the air or liquid medium 324 and mobile particles 326 reside. In certain embodiments, the reflective image display may further include a combination of sidewalls and partial sidewalls that may completely and partially bridge gap 322 created by the front and rear electrodes in the region where medium 324 and electrophoretically mobile particles 326 reside.

A directional front light may be employed with the disclosed display embodiments. The directional front light system may include a light source, light guide and an array of light extractor elements on the outward surface of the front sheet in each display. The directional light system may be positioned between outward surface 306 of the front sheet and the viewer. The front light source may define a light emitting diode (LED), cold cathode fluorescent lamp (CCFL) or a surface mount technology (SMT) incandescent lamp. The light guide may be configured to direct light to the front entire surface of the transparent outer sheet while the light extractor elements direct the light in a perpendicular direction within a narrow angle, for example, centered about a 30° cone, towards the front sheet. A directional front light system may be used in combination with cross-walls or a color filter layer in the display architectures described herein or a combination thereof. In some embodiment, the directional front light system may be flexible.

In some embodiments, a light diffusive layer may be employed with the disclosed display embodiments. In other embodiments, a light diffusive layer may be used in combination with a front light. In some embodiments, the light diffusive layer may be positioned over sheets 302 or 304 facing viewer 308. In other embodiments, the light diffusive layer may be interposed between the sheet 302 and electrode layer 316.

In other embodiments, any of the reflective image display embodiments disclosed herein may further include at least one spacer structure. The spacer structures may be used to control gap 322 between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, polymer or other resin or a combination thereof.

At least one edge seal may be employed with the disclosed display embodiments. The edge seal may prevent ingress of moisture or other environmental contaminants from entering the display. The edge seal may be used to seal front sheet 302 to rear sheet 318. The edge seal may be a thermally, chemically or a radiation cured material or a combination thereof. The edge seal may comprise one or more of an epoxy, silicone, urethane, polyisobutylene, acrylate or other polymer based material. In some embodiments the edge seal may comprise a metallized foil. In some embodiments the edge sealant may comprise a filler, such as SiO₂ or Al₂O₃.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments, the tangible machine-readable non-transitory storage medium may be further used in combination with one or more processors.

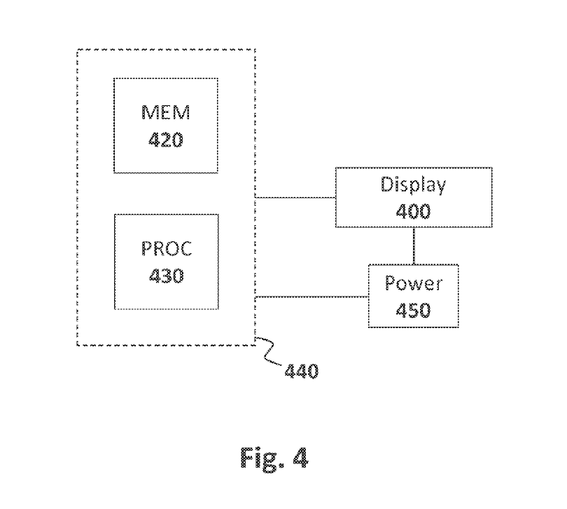

FIG. 4 shows an exemplary system for controlling a display according to one embodiment of the disclosure. In FIG. 4, display 400 is controlled by controller 440 having processor 430 and memory 420. Other control mechanisms and/or devices may be included in controller 440 without departing from the disclosed principles. Controller 440 may define hardware, software or a combination of hardware and software. For example, controller 440 may define a processor programmed with instructions (e.g., firmware). Processor 430 may be an actual processor or a virtual processor. Similarly, memory 420 may be an actual memory (i.e., hardware) or virtual memory (i.e., software).

Memory 420 may store instructions to be executed by processor 430 for driving display 400. The instructions may be configured to operate the display by effectively switching or changing the applied bias to one or more of the front and rear electrodes. In one embodiment, the instructions may include biasing electrodes through power supply 450. When biased, the electrodes may cause movement of electrophoretic particles towards or away from a region proximal to the surface of the plurality of protrusions at the inward surface of the front transparent sheet to thereby absorb or reflect light received at the inward surface of the front transparent sheet. By appropriately biasing the electrodes, particles (e.g., particles 326 in FIG. 3) may be moved near the surface of the plurality of convex protrusions at the inward surface of the front transparent sheet into or near the evanescent wave region in order to substantially or selectively absorb or reflect the incoming light. Absorbing the incoming light creates a dark or colored state. By appropriately biasing the electrodes, particles (e.g., particles 326 in FIG. 3) may be moved away from the surface of the plurality of protrusions at the inward surface of the front transparent sheet and out of the evanescent wave region in order to reflect or absorb the incoming light. Reflecting the incoming light creates a light state.

The exemplary displays disclosed herein may be used as electronic book readers, portable computers, tablet computers, cellular telephones, smart cards, signs, watches, wearables, shelf labels, flash drives and outdoor billboards or outdoor signs comprising a display. The displays may be powered by one or more of a battery, solar cell, wind, electrical generator, electrical outlet, AC power, DC power or other means.

The following exemplary and non-limiting embodiments provide various implementations of the disclosure. Example 1 is directed to an apparatus to display a Totally-Internally Reflected (TIR) image, comprising: a bottom support layer; a front sheet having an index perturbation array (IPA), wherein the array is defined by a plurality of non-absorptive varying refractive index regions with each region diffracting an incoming ray of light differently than at least one other region in the array and wherein each region of the array comprises a different refractive index than at least one other region; and a transparent layer deposited over the IPA layer.

Example 2 is directed to the apparatus of example 1, wherein the IPA defines a contiguous substrate.

Example 3 is directed to the apparatus of example 1, wherein the display comprises a low index of refraction medium further having electrophoretically mobile particles.

Example 4 is directed to the apparatus of example 1, wherein an incident light is re-directed by the IPA such that the angle of the re-directed light is directed toward the interface of a sheet of high refractive index and a low refractive index medium.

Example 5 is directed to the apparatus of example 1, wherein the transparent layer further comprises one or more of glass, transparent polymer or a composite of inorganic particles dispersed in a transparent polymer matrix.

Example 6 is directed to the apparatus of example 1, wherein the array of non-absorptive refractive index variation defines a Bragg grating to diffract an incident light ray into one or more diffracted rays.

Example 7 is directed to the apparatus of example 1, wherein the plurality of regions includes a first region having a high refractive index and a second region having a low refractive index and wherein the difference between the refractive index of the first and second regions is in the range of about 0.01 to 1.5.

Example 8 is directed to the apparatus of example 1, wherein the IPA array further comprises a plurality of regions having high and low refractive indexes which repeat throughout the array.

Example 9 is directed to a Totally-Internally Reflected (TIR) image display system, comprising: a front sheet having an index perturbation array (IPA), wherein the array is defined by a plurality of non-absorptive varying refractive index regions with each region diffracting an incoming ray of light differently than at least one other region in the array and wherein each region of the array comprises a different refractive index than at least one other region; an array of non-absorptive refractive index variations to define the plurality of regions; a front electrode disposed proximal to the front sheet; and a bottom electrode disposed distal to the front sheet, the first electrode and the second electrode forming a cavity therebetween to receive a plurality of electrophoretically mobile particles movable between the front and the bottom electrodes.

Example 10 is directed to the display of example 9, wherein the front sheet comprises at least one of a top transparent layer and a bottom transparent layer, the top transparent layer disposed over the IPA and the bottom transparent layer disposed below the IPA.

Example 11 is directed to the display of example 10, wherein the transparent layer further comprises one or more of glass, transparent polymer or a composite of inorganic particles dispersed in a transparent polymer matrix.

Example 12 is directed to the display of example 10, wherein the bottom transparent layer is integrated with the top electrode.

Example 13 is directed to the display of example 9, further comprising a bias source to bias one or more of the front or the bottom electrodes.

Example 14 is directed to the display of example 9, wherein the cavity is configured to receive a medium having a low index of refraction to form a light modulation layer in the cavity.

Example 15 is directed to the display of example 9, wherein the perturbation array defines a Bragg grating to diffract an incident light ray into one or more diffracted rays.

Example 16 is directed to the display of example 9, wherein the plurality of regions includes a first region having a high refractive index and a second region having a low refractive index and wherein the difference between the refractive index of the first and second regions is in the range of about 0.01 to 1.5.

Example 17 is directed to the display of example 9, wherein the IPA array further comprises a plurality of regions having high and low refractive indexes which repeat throughout the array.

Example 18 is directed to a method to provide Total Internal Reflection (TIR) in a display, the method comprising: positioning at least one electrophoretically mobile particle in a transparent medium disposed between a front electrode and rear electrode of an electrode pair, the front electrode associated with an index perturbation array (IPA), wherein the array is defined by a plurality of non-absorptive varying refractive index regions with each region diffracting an incoming ray of light differently than at least one other region in the array and wherein each region of the array comprises a different refractive index than at least one other region; receiving a first incident light ray at the transparent front sheet; biasing one or more of the electrodes in the electrode pair at a first bias to thereby move the at least one electrophoretically mobile particle to a region at or near the transparent front sheet and to absorb the first incident light; biasing one or more of the electrodes in the electrode pair at a second bias to thereby move the at least one electrophoretically mobile particle to a region at or near the bottom electrode; and receiving a second incident light ray at the transparent front sheet and totally internally reflecting the second incident light ray at one or more of the IPA and the front electrode.

Example 19 is directed to the method of example 18, wherein the front sheet comprises at least one of a top transparent layer and a bottom transparent layer, the top transparent layer disposed over the IPA and the bottom transparent layer disposed below the IPA.

Example 20 is directed to the method of example 19, wherein the transparent layer further comprises one or more of glass, transparent polymer or a composite of inorganic particles dispersed in a transparent polymer matrix.

Example 21 is directed to the method of example 19, wherein the bottom transparent layer is integrated with the top electrode.

Example 22 is directed to the method of example 18, further comprising biasing the front and the rear electrodes simultaneously relative to each other.

Example 23 is directed to the method of example 18, wherein the transparent medium defines a low index of refraction to form a light modulation layer in the cavity.

Example 24 is directed to the method of example 18, wherein the perturbation array defines a Bragg grating to diffract an incident light ray into one or more diffracted rays.

Example 25 is directed to the method of example 18, wherein the plurality of regions includes a first region having a high refractive index and a second region having a low refractive index and wherein the difference between the refractive index of the first and second regions is in the range of about 0.01 to 1.5.

While the principles of the disclosure have been illustrated in relation to the exemplary embodiments shown herein, the principles of the disclosure are not limited thereto and include any modification, variation or permutation thereof.

What is claimed is:

1. An apparatus to display a Totally-Internally Reflected (TIR) image, comprising:
a bottom support layer;
a front sheet having an index perturbation array (IPA), wherein the array is defined by a plurality of non-absorptive varying refractive index regions with each region diffracting an incoming ray of light differently than at least one other region in the array and wherein each region of the array comprises a different refractive index than at least one other region; and
a transparent layer deposited over the IPA layer.

2. The apparatus of claim 1, wherein the IPA defines a contiguous substrate.

3. The apparatus of claim 1, wherein the display comprises a low index of refraction medium further having electrophoretically mobile particles.

4. The apparatus of claim 1, wherein an incident light is re-directed by the IPA such that the angle of the re-directed light is directed toward the interface of a sheet of high refractive index and a low refractive index medium.

5. The apparatus of claim 1, wherein the transparent layer further comprises one or more of glass, transparent polymer or a composite of inorganic particles dispersed in a transparent polymer matrix.

6. The apparatus of claim 1, wherein the array of non-absorptive refractive index variation defines a Bragg grating to diffract an incident light ray into one or more diffracted rays.

7. The apparatus of claim 1, wherein the plurality of regions includes a first region having a high refractive index and a second region having a low refractive index and wherein the difference between the refractive index of the first and second regions is in the range of about 0.01 to 1.5.

8. The apparatus of claim 1, wherein the IPA array further comprises a plurality of regions having high and low refractive indexes which repeat throughout the array.

9. A Totally-Internally Reflected (TIR) image display system, comprising:
a front sheet having an index perturbation array (IPA), wherein the array is defined by a plurality of non-absorptive varying refractive index regions with each region diffracting an incoming ray of light differently than at least one other region in the array and wherein each region of the array comprises a different refractive index than at least one other region;
an array of non-absorptive refractive index variations to define the plurality of regions;
a front electrode disposed proximal to the front sheet; and
a bottom electrode disposed distal to the front sheet, the first electrode and the second electrode forming a cavity therebetween to receive a plurality of electrophoretically mobile particles movable between the front and the bottom electrodes.

10. The display of claim 9, wherein the front sheet comprises at least one of a top transparent layer and a bottom transparent layer, the top transparent layer disposed over the IPA and the bottom transparent layer disposed below the IPA.

11. The display of claim 10, wherein the transparent layer further comprises one or more of glass, transparent polymer or a composite of inorganic particles dispersed in a transparent polymer matrix.

12. The display of claim 10, wherein the bottom transparent layer is integrated with the top electrode.

13. The display of claim 9, further comprising a bias source to bias one or more of the front or the bottom electrodes.

14. The display of claim 9, wherein the cavity is configured to receive a medium having a low index of refraction to form a light modulation layer in the cavity.

15. The display of claim 9, wherein the perturbation array defines a Bragg grating to diffract an incident light ray into one or more diffracted rays.

16. The display of claim 9, wherein the plurality of regions includes a first region having a high refractive index and a second region having a low refractive index and wherein the difference between the refractive index of the first and second regions is in the range of about 0.01 to 1.5.

17. The display of claim 9, wherein the IPA array further comprises a plurality of regions having high and low refractive indexes which repeat throughout the array.

18. A method to provide Total Internal Reflection (TIR) in a display, the method comprising:
positioning at least one electrophoretically mobile particle in a transparent medium disposed between a front electrode and rear electrode of an electrode pair, the front electrode associated with an index perturbation array (IPA), wherein the array is defined by a plurality of non-absorptive varying refractive index regions with each region diffracting an incoming ray of light differently than at least one other region in the array and wherein each region of the array comprises a different refractive index than at least one other region;
receiving a first incident light ray at the transparent front sheet;
biasing one or more of the electrodes in the electrode pair at a first bias to thereby move the at least one electrophoretically mobile particle to a region at or near the transparent front sheet and to absorb the first incident light;
biasing one or more of the electrodes in the electrode pair at a second bias to thereby move the at least one electrophoretically mobile particle to a region at or near the bottom electrode; and
receiving a second incident light ray at the transparent front sheet and totally internally reflecting the second incident light ray at one or more of the IPA and the front electrode.

19. The method of claim 18, wherein the front sheet comprises at least one of a top transparent layer and a bottom transparent layer, the top transparent layer disposed over the IPA and the bottom transparent layer disposed below the IPA.

20. The method of claim 19, wherein the transparent layer further comprises one or more of glass, transparent polymer or a composite of inorganic particles dispersed in a transparent polymer matrix.

21. The method of claim 19, wherein the bottom transparent layer is integrated with the top electrode.

22. The method of claim 18, further comprising biasing the front and the rear electrodes simultaneously relative to each other.

23. The method of claim 18, wherein the transparent medium defines a low index of refraction to form a light modulation layer in the cavity.

24. The method of claim 18, wherein the perturbation array defines a Bragg grating to diffract an incident light ray into one or more diffracted rays.

25. The method of claim 18, wherein the plurality of regions includes a first region having a high refractive index and a second region having a low refractive index and wherein the difference between the refractive index of the first and second regions is in the range of about 0.01 to 1.5.
